(19) United States
(12) Patent Application Publication
(10) Pub. No.: US 2021/0046732 A1
(43) Pub. Date: Feb. 18, 2021

(54) COMPOSITE STRUCTURE FOR AN AIRBAG COVER, AND SEWN PRODUCT OF THE COMPOSITE STRUCTURE

(71) Applicant: TMG - Tecidos Plastificados e Outros Revestimentos Para a Indústria Autómovel, S.A., S Cosme do Vale, V.N. Famalicão (PT)

(72) Inventors: Elizabete de Pinho, Porto (PT); Luis Filipe Silva, Braga (PT); Valério Gonçalves, Póvoa de Lanhoso (PT); Julia Burk, Oberhausen (DE); Tom Marquart, Landshut (DE)

(73) Assignee: TMG - Tecidos Plastificados e Outros Revestimentos Para a Indústria Autómovel, S.A., S Cosme do Vale, V.N. Famalicão (PT)

(21) Appl. No.: 16/976,089

(22) PCT Filed: Feb. 19, 2019
(86) PCT No.: PCT/EP2019/054109

§ 371 Date: Aug. 27, 2020

(30) Foreign Application Priority Data
Mar. 1, 2018 (EP) 18159405.2

(51) Int. Cl. B32B 7/09; B32B 5/02; B32B 5/18; B32B 5/24; B32B 7/022; B32B 27/06; B32B 27/12; B32B 27/08; B32B 27/32; B32B 27/30; B32B 37/02; B32B 37/06; B32B 37/12; B32B 7/12; B32B 37/18; B32B 38/06; B29C 48/21

(52) U.S. Cl. CPC B32B 7/09; B29K 2101/12; B32B 5/024; B32B 5/026; B32B 5/18; B32B 5/245; B32B 7/022; B32B 27/065; B32B 27/12; B32B 27/08; B32B 27/32; B32B 27/304; B32B 37/02; B32B 37/06; B32B 37/1207; B32B 7/12; B32B 37/182; B32B 38/06; B29C 48/21; B32B 2037/1215; B32B 2255/10; B32B 2255/26; B32B 2266/025; B32B 2305/022; B32B 2305/186; B32B 2305/188; B32B 2305/20; B32B 2307/536; B32B 2323/10; B32B 2327/06; B32B 2605/08; B32B 5/022

(57) ABSTRACT

The present invention provides a composite structure, a method for its manufacture, a sewing product containing the composite structure, and a method for manufacturing the sewing product. The composite structure has a Shore A hardness according to DIN 53505 of 20 to 45 and comprises a foam layer, a cover, layer and a lacquering layer in this order, wherein the foam layer has a density of 40 to 100 kg/m³ and a gel content of 20 to 80% and contains a polyolefin and the cover layer has a gel content of 0 to 20%, is thermoplastic and comprises at least two compact sublayers each comprising at least one thermoplastic selected from polyolefin and polyvinyl chloride.

### FIELD OF THE INVENTION

The present invention relates to a composite structure as a cover for an airbag cover, a sewn product and a process for producing the composite structure and the sewn product.

### State of the Art

Airbags are integrated in various places in motor vehicles, for example in steering wheels, instrument panels, doors, seats and roof linings. For the airbag to function reliably, it is necessary for the plastic carrier to have one or more material weaknesses in all its layers, so-called predetermined breaking points, which define the airbag's deployment channel. In the area, of the covers of an airbag, it is common practice to provide the cover of the airbag in the area of the airbag flap with a so-called tear seam so that it can open unhindered in the event of an impact and the airbag can deploy.

However, for visual reasons or design reasons, car manufacturers are increasingly demanding that, for example, the passenger airbag, which is integrated into the dashboard, be invisible on the side facing the occupant. For this purpose, the dashboard with the integrated airbag flap is provided with a cover without a tear seam.

However, this coating must have a material weakening in the area of the airbag flap so that a safe airbag deployment, i.e, the safe opening of the airbag flap and the deployment of the airbag in the event of an impact, is guaranteed. The opening of the cover during the airbag shot along the material weaknesses must also take place within a specified time window. Uncontrolled particle flight caused by flying fragments of the cover must also be avoided at all costs.

Film materials can be used as an alternative to airbag cover coatings with material weakening. These film materials must show the required tearing behavior, whereby the airbag must be deployed within defined time limits, particle flight must be avoided and passenger protection must be guaranteed.

In the case of slush or sprayed skin, the produced skin is back-foamed with a foam. This foam is simultaneously bonded to a stable carrier part. In these constructions, when an airbag is opened, the airbag flap is driven by the bag against the foam, which breaks in the process. In the further course of the process, the flap meets the compact inner layer of the two-layer compact film construction, which does not break immediately due to its significantly higher strength and extensibility, but is first stretched.

PVC or PUR materials are used as dashboard covers for luxury vehicles. Spacer materials are usually used as a haptic layer. Recently, so-called “multitear” spacer materials have been developed that can be used for airbag covers without weakening the material.

The use of foam laminates for airbag covers is described in DE 10 2014 213 974 A1. The foam film laminate described there comprises a compact cover layer and a foam layer with a density of at least 350 kg/m³ on the underside of the cover layer, the cover layer having an outer layer and an inner layer.

The use of film laminates for airbag covers is also described in DE 10 2016 206 340 A1. The film laminate described there comprises a compact cover layer and a foam layer with a thickness in the range of 0.5 to 4 mm and a density of 40 to 200 kg/m³ on the underside of the cover layer, whereby the cover layer can, be designed in two layers.

A disadvantage of these composite structures is their low flexibility and softness, especially when the density of the foam layer is high. On the other hand, these structures can have a low thickness. This results in disadvantages with regard to haptics and handling during processing.

### Problems to be Solved by the Invention

The state of the art does not discloses any composite structures which on the one hand have good properties as airbag covers, especially tearing properties, without weakening the material, and on the other hand are soft and flexible, so that they are advantageous in terms of haptics and handling during processing. In particular, the composite structures should be easy to sew.

Therefore, the purpose of the present invention is to provide a composite structure and a sewn product with an improved combination of properties such as tearing properties, haptics, wrinkling and handling during processing, in particular during sewing.

### SUMMARY OF THE INVENTION

The problem was solved by providing a composite structure and a sewing product according to the enclosed patent claims.

The subject matter of the present invention is in particular the following points [1] to [15]:

[1] A composite structure having a Shore A hardness according to DlN 53505 of 20 to 45, comprising a foam layer, a cover layer and a lacquering layer in this order, the foam layer having a density of 40 to 100 kg/m³ and a gel content of 20 to 80% and containing a polyolefin and the cover layer having a gel content of 0 to 20%, being thermoplastic and comprising at least two compact sublayers each comprising at least one thermoplastic selected from polyolefin and polyvinyl chloride.

[2] The composite structure according to [1], wherein the gel content of the cover layer is 3 to 15%, the sublayers of the cover layer contain polyolefin and the sublayer of the cover layer closest to the foam layer has a Shore A hardness of 75 to 95 and the sublayer adjacent thereto has a lower Shore A hardness.

[3] The composite structure according to [1], wherein the gel content of the cover layer is 1 to 5%, the sublayers of the cover layer contain polyvinyl chloride and together have a Shore A hardness of 30 to 60.

[4] The composite structure according to any one of points [1] to [3], which is suitable as a tearable coating for an airbag cover without material weakening.

[5] The composite structure according to any of the foregoing points, wherein the polyolefin of the foam layer contains or consists of polypropylene.

[6] The composite structure according to any of the foregoing points, wherein a textile layer of a thickness of 0.05 to 2 mm is arranged between the foam layer and the cover layer.

[7] The composite structure according to any of the foregoing points, where the thickness of the foam layer is 1 to 5 mm and the thickness, of the cover layer is 0.2 to 1 mm.

[8] The composite structure according to one of the foregoing points, wherein the foam layer consists of sharpened foam.

[9] A process for producing a composite structure according to any one of points [1] to [8], wherein the sublayers of the cover layer contain thermoplastic polyolefin and no textile layer is disposed between the foam layer and the cover layer, the process comprising the following steps (i) to (iii) in one of the alternative sequences indicated;
(i) coextruding the sublayers of the cover layer and thermally laminating to the foam layer,
(ii) lacquering the cover layer and,
(iii) if the composite structure has a grain, embossing the structure to form the grain; or
(i) coextruding the sublayers of the cover layer,
(ii) lacquering the cover layer and,
(iii) if the composite structure has a grain, embossing the structure to form the grain and thermally laminating it to the foam layer.

[10] A process for producing a composite structure according to any one of points [1] to [8], wherein the sublayers of the cover layer contain thermoplastic polyolefin and a textile layer is arranged between the foam layer and the cover layer, the method comprising the following steps:
(i) coextruding the sublayers of the cover layer,
(ii) lacquering the cover layer,
(iii) hot-melt bonding the cover layer and the foam layer to the textile layer and,
(iv) if the composite structure has a grain, embossing the structure,

wherein the steps are performed in the order indicated or in the order (i), (iii), (ii) and (iv).

[11] A process for producing a composite structure according to any one of points [1] to [8], wherein the sublayers of the cover layer contain thermoplastic polyvinyl chloride and a textile layer is arranged between the foam layer and the cover layer, the process comprising the following steps:
(i) providing the textile layer with laminated sublayers of the cover layer
(ii) lacquering the cover layer,
(iii) if the composite, structure has a grain, embossing the structure; and
(iv) hot-melt bonding the foam layer to the textile layer.

[12] A sewn product obtainable by sewing together at least two sheets of the composite structure according to any one of points [1] to [8],

[13] The sewn product according to [12], wherein the product is obtainable by folding the composite structure, placing the foam layers together and sewing the two parts of the composite structure in the contact area.

[14] The sewn product according to [12] or [13], wherein the thickness of the foam layer in the area of the seam has been reduced before sewing.

[15] The use of a composite structure according to, any of points [1] to [8] or a sewn product according to any of points [12] to [14] as a coating material for a component in the interior of a vehicle.

### Advantages of the Invention

The composite structure according to the invention exhibits a tear behavior that meets the requirements for airbag opening without weakening the composite structure or decorative material. On the one hand, this avoids a visible weakening line, which is considered a flaw in the design.

The main advantage, however, is that the manufacturing costs can be reduced. The composite structure as invented, represents a cost-effective alternative to the high-priced PVC or PUR materials with spacer materials. In particular, the sewability of the composite structure in accordance with the invention enables it to be used as an alternative to the materials mentioned. Thus, the composite structure according to the invention can also be used in luxury class vehicles.

The composite structures according to the invention have a low wrinkle formation when bent. This makes them easier to handle and, in particular, facilitates sewing.

Due to the special multi-layer structure, the composite structures according to the invention have further properties that are advantageous when sewing. These properties are, in particular, seam strength, i.e. a high stitch tear-out force, as well as a high tear propagation resistance,

Due to the low thickness of the outer compact layer, the material base in this layer can be selected to meet specific requirements such as surface resistance, gloss, grain appearance, aging resistance and the like.

A further advantage is the easy recycleability of the composite structure according to the invention when a polyolefin foam and a thermoplastic polyolefin are used as the cover layer, since they belong to the same compound family.

### DESCRIPTION OF THE FIGURE

FIG. 1 shows the results of elongation at break tests of composite structures according to the invention (example 4: dashed line; example 6: dotted line) and a composite structure of the state of the art (C212: solid line),

### EMBODIMENTS OF THE INVENTION

The composite structure according to the invention is a composite structure with a Shore A hardness according to DIN 53505 of 20 to 45 with a foam layer, a cover layer and a lacquering layer in this order, wherein the foam layer has a density of 40 to 100 kg/m³ and a gel content of 20 to 80% and contains a polyolefin and the cover layer has a gel content of 0 to 20%, is thermoplastic and contains at least two compact sublayers each with at least one thermoplastic selected from polyolefin and polyvinyl chloride.

A composite structure is preferred in which the cover layer is thermoplastic and consists of at least two polyolefin-based sublayers, with no adhesive between the foam layer and the cover layer.

In one embodiment, the composite structure has a cover layer with three sublayers, with all three sublayers being polyolefin-based or PVC-based. In the case of thermoplastic polyolefin, it is particularly preferred that the one closest to the foam layer, i.e. the inner sublayer of the cover layer and the outer sublayer, have the same composition and the middle sublayer has a different composition.

Very preferably the composite structure according to the invention comprises a polypropylene-based, sharpened foam layer having a thickness of 1.0 to 5.0 mm, a cover layer having a thickness of 0.2 to 1.0 mm and a lacquering layer having a thickness of 1 to 30 μm in this order and optionally a textile layer having a thickness of 0.05 to 1.0 mm between the foam layer and the cover layer, the composite structure optionally having an elongation at break of 80 to 220%.

The composite structure according to the invention is preferably suitable as a tearable coating for an airbag cover. The term “suitable as a tearable coating for an airbag cover” means that the composite structure of the invention is located in an area of the airbag cover where the predetermined breaking point of the cover is located. When the airbag is triggered, i.e, when the airbag is fired, this predetermined breaking point breaks and causes the composite structure according to the invention to tear.

In order for the composite structure according to the invention to have the desired properties, e.g. easy processability when sewing, the composite structure must not be too hard. The Shore A hardness of the composite structure according to the invention is therefore preferably 20 to 45 and more preferably 30 to 45.

The composite structure according to the invention preferably has no material weakening. The term “material weakening” can mean any physical weakening and can refer, for example, to an area where material has been removed to form predetermined breaking lines, or a tear seam or perforation line. The composite structure according to the invention is preferably “without material weakening”, i.e. the said weakening of the material is not present in the composite structure according to the invention.

In order to prevent impairment of airbag deployment or so-called ballooning, it is preferable that all layers of the composite structure tear as simultaneously as possible. The elongation at break (according to ISO 1421) of the composite structure according to the invention is preferably between 60 and 250%, more preferably between 80 and 220% and even more preferably between 100 and 200%. Preferably the elongations at break of the other layers of the composite structure are in the same range, the difference between the elongation at break of each layer and the elongation at break of the composite structure being less than 50%, more preferably less than 20%, and even more preferably less than 10%.

According to ISO 2411, the adhesive force between the individual layers is preferably so high that it is not possible to separate two layers, i.e. cover layer and foam layer and, if necessary, cover layer and textile layer and textile layer and foam layer, without destroying the layers. In particular, it is preferred that separation of the foam layer from a cover layer or textile layer bonded to it is not possible without destroying the foam layer (foam splitting). This objective can be achieved by the appropriate selection of the thermoplastic materials of the cover layer or the sublayer of the cover layer adjacent to the foam layer or the type of adhesive that bonds the foam layer to the textile layer.

For suitability for sewing, it is important that the composite structure according to the invention has a suitable stitch tear-out force. This is preferably at least 40 N according to DIN EN ISO 23910.

Foam Layer

The foam layer contains polyolefin foam or consists of polyolefin foam. The polyolefins described below in relation to thermoplastic polyolefins can be used in this foam. The foam layer consists of or contains polypropylene foam (PP foam) in a preferred embodiment. Polypropylene (PP) is understood here to be such polymers or copolymers whose proportion of propylene is >50% by weight.

The polyolefin of the foam layer may contain common additives, such as lubricants, stabilizers, fillers, such as inorganic fillers, and/or pigment.

The thermoplastic polyolefins (TPC) described below in relation to the cover layer can also be used for the foam layer.

The preferred polypropylene may be selected from the group consisting of polypropylene, polypropylene-ethylene copolymer, metallocene polypropylene, metallocene polypropylene-ethylene copolymer, polypropylene-based polyolefin plastomer, polypropylene-based polyolefin elastoplastomer, polypropylene-based polyotefin elastomer, polypropylene-based polyolefin elastomer, polypropylene-based thermoplastic polyolefin blend and polypropylene-based thermoplastic elastomer blend.

Polypropylene-based thermoplastic polyolefin blend is homopolypropylene and/or polypropylene-ethylene copolymer and/or metallocene homopolypropylene.

The thickness of the foam layer is preferably 1.0 to 5.0 mm, more preferably 2.0 to 5.0 mm and even more preferably 3.0 to 4.5 mm.

The density of the foam layer is 40 to 100 kg/m³, preferably 40 to 70 kg/m³.

The higher the density of the foam, the higher its strength. In order for the foam layer to exhibit the properties desired for the invention, the preferred values of the density and the thickness of the foam layer correlate. Overall, however, the foam layer has a very low density. This is also reflected in the product of the density (in kg/m³) and the thickness in mm) of the foam layer. This product is preferably 100 to 300, more preferably 150 to 250.

A measure of the softness of the foam layer is the gel content. The gel content is an indication of the degree of cross-linking of the polymer. The lower the gel content, the softer the foam layer. The foam layer used in the composite structure according to the invention has a gel content of 20 to 80%, preferably 30 to 60% and more preferably 40 to 60%.

The foamed layer is preferably formed by foam extrusion. In this process, the layer of foamed plastic is produced in that the plastic melt is loaded during the extrusion process above the melting temperature with a blowing agent under excess pressure, in particular an inert gas, by blowing it in, and this gas-containing melt is then expanded on leaving the extrusion unit and cooled below the melting temperature. The layer of foamed plastic is thus produced by blowing a blowing agent under positive pressure into a plastic melt during the extrusion process and by subsequently releasing the blowing agent under positive pressure. The blowing agent can be e.g. H₂O or inert gases, possibly in combination with each other. In order to achieve pronounced foam formation, an inert gas is advantageously used as the blowing agent or a blowing agent containing an inert gas is used. All inert gases known to the skilled person can be used as inert gases in the process, whereby CO₂ or N₂ have proven to be particularly advantageous with regard to price, environmental compatibility and foaming behavior. The foam material can then be bonded, e.g. thermally or by gluing, to the compact two-layer cover layer in the form of a flat material, so that a multi-layer plastic film with a foamed layer is produced. It is also possible to first bond the foam layer to the inner layer and then apply the outer layer to the inner layer.

The foam contained in the foam layer can be open-cell or closed-cell. Especially when PP foam is produced as sheets, the cell structure on the surfaces differs from the rest of the homogeneous structure. In particular, the surfaces have harder, closed-cell areas. This results in different physical properties, for example different elongation and flexibility, but also different haptics. By so-called skiving of the lower and/or upper cover layer of the sheet, it is possible to obtain a sheet that contains the homogeneously cell-structured core area of the foam. This process results in a so-called sharpened foam. The sharpening can be limited to one or more areas, e.g. the edges, of the sheet or can cover the entire sheet. The foam sheet is sharpened in such a way that, for example, at least 2%, 5%, 10% or 20% of the thickness of an portion or the entire sheet is removed on one or both surfaces, with preferred areas being 2 to 20% or 5 to 15% on one or both surfaces. The sharpened sheet then has a thickness of preferably 1 to 5 mm. This makes the feel of the later foam film much softer and the material is easier to handle during the production process of the sewing dresses and during lamination. The foam can be sharpened before the composite structure is formed, whereby one or both surfaces can be sharpened. It is preferable to sharpen both surfaces fully. After bonding the foam to the cover layer or to the textile layer, it can be sharpened on the still free surface.

The use of sharpened foam with an open-cell surface also has the advantage that in the area of connection with another layer, the material of this other layer or the adhesive can penetrate into the open cells and a stronger connection can be achieved by the anchoring obtained in this way.

Sharpening in the seam area can be carried out with a sharpening machine, e.g. FORTUNA NG6 (rotating bell knife with adjustable knife speed).

This method also has a very positive influence on the avoidance of creases when handling the material in the sewing process. The sharpening process in the seam area is also necessary in order to be able to fold over and topstitch the seam flags and to reduce or avoid the associated thickening of the material. For example, the foam layer can be reduced to half the original thickness. In the seam area of two composite structures or two parts of a composite structure, the reduction in foam thickness is preferably such that the thickness in the seam area does not differ from the thickness in the adjacent, non thickness-reduced area or is at most 50%, preferably at most 30%, more preferably at most 20% and even more preferably at most 10% greater.

The properties of the composite structure have been selected in such a way that sufficient seam strength according to DIN ISO 23910 is achieved without having to use an extra sewing aid, e.g. a thin textile. The seam strength is determined by the thickness and the structure of the composite structure, among other things.

The foam layer, for example, has a thickness of 33 mm. The cover layer, for example, has a thickness of 0.5 mm. The total thickness is therefore 4.0 mm. If the total thickness is to be retained when the seam lug of a composite structure is turned down, 4.0 mm must be removed in this area. This can be achieved by removing 2.0 mm of the foam layer so that the foam layer has a thickness of only 1.5 mm. If this area is folded over, a total thickness of the foam of 3.0 mm remains in the overlap area, so that the properties of the composite structure in this area and the properties of the composite structure in other areas are at least similar.

It is particularly preferred that a sewing product according to the invention contains a foam layer which has been subjected to a full-surface sharpening of at least one surface, in particular both surfaces. Even more preferred is a foam layer which has been subjected both to a full-surface sharpening of both surfaces and a sharpening in the seam area.

Examples of polyolefins and their production are disclosed in U.S. Pat. No. 9,260,577B2.

These polyolefins comprise 15 to 75 parts by weight of an olefin block copolymer and 25 to 85 parts by weight of a propylene-based polymer and have a degree of crosslinking of 20 to 75%. These polyolefins preferably contain closed cells.

For example, the degree of crosslinking may be 30 to 50%, with crosslinking being carried out with 3 to 4 parts by weight of divinylbenzene crosslinker per 100 parts by weight of resin.

These polyolefins, which can be produced according to U.S. Pat. No. 9,250,577B2, for example, have the following properties:

| | | | Properties |
|---|---|---|---|
| | | Properties of | of very |
| | Properties | particularly | particularly |
| | of preferred | preferred | preferred |
| | polyolefins | polyolefins | polyolefins |
| Compressive strength | 0.2-1.0 | 0.3-0.6 | 0.75-0.85 |
| according to JIS K6767 | | | |
| [kgf/cm²] | | | |
| Density [kg/m³] | 20-250 | 30-100 | 65-75 |
| according to JIS K6767 | | | |
| Shore A according to | 30-90 | 45-65 | 70-75 |
| ASTM D2240 | | | |
| VDA 237-101 Section | 1.0-3.2 | 1.0-2.8 | 2.3-2.5 |
| (Appendix) 1 | | | |

The standards listed in the above table and their implementation are explained in U.S. Pat. No. 9,260,577B2.

Cover Layer

The cover layer is thermoplastic. It contains a thermoplastic polyolefin (TPO) and/or a thermoplastic polyvinyl chloride (PVC). Preferably, the cover layer consists of a TPO or PVC. The expression that a layer “contains” TPO or PVC means that it preferably consists of at least 30% by weight of TPO or PVC, more preferably at least 50% by weight and even more preferably 100%. The expression that a layer is “based” on TPO or PVC means that it consists of at least 50%, preferably 100%, by weight of TPO or PVC.

The cover layer has at least two sublayers. If there are two or three sublayers, the sublayer closest to the foam layer is called the inner sublayer. Correspondingly, the sublayer closest to the lacquering layer is called the outer layer. If there are three sublayers, the intermediate sublayer is referred to as the middle sublayer.

Preferably, the cover layer comprises two or three sublayers.

The cover layer consists of or contains a thermoplastic selected from TPO and/or PVC. The thermoplastic is contained in at least one of the sublayers and preferably in all sublayers. If both TPO and PVC are present, they may be present in the same sublayer or in different sublayers.

The connection between the outer layer, the middle layer and the inner layer and between the inner layer and the foam layer can be made in the usual way, e,g, thermally or by bonding.

Preferably, the Shore A hardness of the cover layer is 90 or less, more preferably 85 or less in the case of a polyolefin-based cover layer, and 60 or less, more preferably 50 or less in the case of a PVC-based cover layer. A range of 75 to 95 is preferred for a polyolefin-based cover layer, more preferably 75 to 85. A range of 30 to 60 is preferred for a PCV-based cover layer, and 30 to 50 is more preferred for a PCV based cover layer.

With two sublayers, the material composition of the layer material for the outer layer and that of the layer material for the inner layer is different. This can be achieved, for example, by varying the type and/or proportions of the polymers used and/or varying the quantity and/or type of additives, especially fillers. In the case of three or more layers, the material composition of adjacent layers is different. Therefore, for example, with three layers, the inner and outer layers can have the same composition.

The thickness of the cover layer is preferably 0.2 to 1 mm, more preferably 0.2 to 0.7 mm and even more preferably 0.3 to 0.6 mm. The sublayers can have the same or different thickness. In one embodiment, the outer layer can be thicker than the inner layer in two layers.

With two sublayers of TPO, both have a thickness of preferably 100 to 400 μm, more preferably 100 to 250 μm. With three sublayers, all preferably have a thickness of 70 to 250 μm, more preferably 100 to 200 μm.

With two sublayers of PVC, both have a thickness of preferably 100 to 500 μm. With three sublayers, all preferably have a thickness of 100 to 600 μm, more preferably 150 to 500 μm. Where the PVC sublayer bonded to a textile layer, if any, serves as an adhesive layer, this layer will preferably be 20 to 80 μm thick, and the other two PVC sublayers will preferably be 100 to 600 μm thick, more preferably 150 to 500 μm thick.

The cover layer is compact. In particular, the cover layer is not foamed. The density of the cover layer is preferably higher than 800 kg/m³ and more preferably higher than 850 kg/m³. This applies to each sublayer independently. The structure according to the invention contains at least two compact sublayers in the cover layer. This means that each of the two sublayers has a density of preferably higher than 800 kg/cm³.

As for the foam layer, the gel content of the cover layer is a measure of the softness of the layer. The cover layer used in the composite structure according to the invention has a gel content of 0 to 20%, preferably of more than 0% to a maximum of 20%. In a polyolefin-based cover layer, the gel content is preferably 3 to 20% or 5 to 20%. In a PVC-based cover layer the gel content is preferably 1 to 10% or 1 to 5%.

TPO

The cover layer, which is used in the composite structure according to the invention, contains or consists of thermoplastic polyolefin.

Thermoplastic polyolefins (TPO) are polyolefins are polymers produced from alkenes such as ethylene, propylene, 1-butene or isobutene by chain polymerization. They are semi-crystalline thermoplastics that are easy to process.

Examples of TPO are polyethylene (PE), polypropylene (PP), polymethylpentene (PMP), polylsobutylene (PIB) and polybutylene (PB, polybutene-1).

Polyethylene (PE) is understood here to be those polymers or copolymers whose weight proportion of ethylene is >50% by weight. Polypropylene (PP) is understood here to be those polymers or copolymers whose proportion of propylene by weight is >50% by weight.

Examples of TPO are mixtures of polyethylene (PE) and polypropylene (PP).

Examples of PE are HDPE, LDPE and LLDPE. HDPE has weakly branched polymer chains and therefore has a high density between 0.94 g/cm³ and 0.97 g/cm³, with a stress at the yield point of 20.0 to 30.0 N/mm² and an elongation of 12% at the yield point. LDPE has highly branched polymer chains and therefore low density between 0.915 g/cm³ and 0.935 g/cm³, with a stress at the yield point of 8.0 to 10.0 N/mm² and an elongation of 20% at the yield point. LLDPE is a linear low density polyethylene whose polymer molecules have only short branches and has a yield stress of 10.0 to 30.0 N/mm² and an elongation of 16% at the yield point.

The properties of TPO can be influenced by adding elastomers or other substances such as talcum.

Depending on its composition, TPO can be produced hard or soft. Hard TPO, for example, consists of 75% PP and talcum. Soft TPO has a significantly higher elastomer content, sometimes up to 70%.

Thermoplastic elastomers can be added to adjust the properties. These are also thermoplastics, which behave rubber-elastically in the range of usual service temperatures, but can be processed like thermoplastics at higher temperatures. A distinction is made between copolymers and elastomer alloys. Copolymers are statistical copolymers or block copolymers, which consist of a main polymer such as polyethylene, whose degree of crystallization is reduced to a certain extent by a randomly incorporated comonomer such as vinyl acetate. In block copolymers, the hard and soft segments in a molecule are sharply separated (e.g. SBS, SIS). Copolymers can therefore consist of a soft elastomer and a hard thermoplastic component.

Elastomer alloys are blends of finished polymers. The desired properties can be obtained by varying the mixing ratios and additives. For example, a polyolefin elastomer made of polypropylene (PP) and natural rubber (NR) covers a wide range of hardness depending on the ratio of quantities.

Examples of TPO are blends of ethylene-propylene-diene rubber (EPDM) with polyethylene (PE) and/or polypropylene (PP), blends of ethylene-propylene rubber (EPM) with polypropylene (PP) and/or polyethylene (PE) and ethylene-propylene blends.

The remarks on polypropylene in this section apply not only to the cover layer, but equally to the PP foam layer.

PVC

The cover layer used in an embodiment in the composite structure according to the invention contains or consists of thermoplastic polyvinyl chloride (PVC). The properties of PVC are adjusted by adding plasticizers. The addition of plasticizers gives the polymer plastic properties such as yielding and softness. Plasticizers include phthalic acid esters, chloroparaffins, adipic acid esters, phosphoric acid esters acetyltributyl citrate and 1,2-cyclohexanedicarboxylic acid diisononyl ester. PVC may contain up to 40% plasticizers.

PVC can be mixed with additives to improve its physical properties, such as toughness and elasticity, and to enhance processability. Examples of such additives are stabilizers and impact modifiers.

For example, PVC without plasticizer can have an elongation at break/tensile strength at break (according to DIN 53455) of 10 to 50%, while PVC can have an elongation at break/tensile strength at break (according to DIN 53455) of 170 to 400%, depending on the structure and quantity of plasticizer.

If the inner cover layer is a PVC layer, it can also serve as an adhesive to adhere to the foam or textile layer.

Surface Lacquering

Surface lacquering serves to protect the artificial leather from chemical agents, physical damage, e.g, scratches or abrasion, and UV radiation. Surface lacquering can further reduce the surface adhesion of the artificial leather. Conventional varnishes can be used, which have proven their worth in the surface finishing of imitation leather for the interior of vehicles. For example, solvent- or water-based polyurethanes cross linked with isocyanates or with UV-curing properties are suitable.

The surface lacquering is preferably applied continuously over the composite structure and covers it completely. The surface lacquering is formed from at least one lacquering layer, but may be formed from several lacquering layers, preferably from one to four lacquering layers.

The surface lacquering to protect the surface usually consists of one or more, preferably up to four, transparent layers of lacquering. However, in a variant of the invention, the surface lacquering may also be colored, e.g. by adding color pigments to the varnish.

The surface lacquering is formed by applying a varnish in one or preferably several coats. The varnish is preferably applied by means of gravure printing, but can also be applied by other methods, such as roller application, spray application or in an embossing step for surface embossing.

In one version, the surface lacquering can be applied in the form of a varnish layer in a two-stage roller printing process. The surface lacquering has a thickness in the range of a few micrometers, preferably 1 to 30 μm, more preferably 1 to 20 μm and even more preferably 3 to 10 μm.

The lacquering layer is preferably a polyurethane lacquering layer. An example of a surface lacquering is a coating based on a silicone-containing aliphatic polyurethane. This varnish can be applied in a thickness of 5 μm, for example.

Graining

The composite structure preferably has a grain. The compact cover layer or outer layer of the cover layer preferably has a three-dimensionally structured surface on the top side, namely a so-called grain, which is possible in a wide variety of shapes and designs that can be used for decoration. The graining has heights and depths, whereby the thickness of the cover layer in the area of the heights differs from the thickness of the cover layer in the area of the depths, for example by at least 0.01 mm, by at least 0.05 mm, by at least 0.1 mm or by at least 0.5 mm.

The graining is covered with the lacquering layer. Depending on the manufacturing process, the grain can be present in the lacquering layer as well as in the cover layer. If the graining is carried out before the lacquering process, the depths of the grains are to some extent filled by the lacquering process. If the graining is carried out after lacquering, the graining is equally present in the varnish and the cover layer.

The grain can be produced using conventional methods. The grain can be produced as a paper grain. For this purpose, the starting material is coated as a PVC or PU mass onto a structured carrier material, e.g. a release paper. Afterwards, the carrier paper is removed and the surface lacquering is applied in several steps by means of gravure printing. Alternatively, the graining or embossing is preferably applied to the artificial leather surface by means of an embossing roller while applying pressure and temperature after the lacquering. Due to the grain, the composite structure has areas of greater and lesser thickness.

Textile Layer

A textile layer is optional. The textile layer contains or consists of a textile material. If the composite structure according to the invention contains a textile layer, it is located between the foam layer and the cover layer. The textile layer may be bonded to the adjacent layers by means of adhesive. Preferably, the textile layer is bonded to both the foam layer and the cover layer with an adhesive. If the sublayer of the cover layer adjacent to the textile layer is a PVC layer, there is no need for an adhesive between the textile layer and the cover layer. In this case, the PVC layer serves as the adhesive.

The textile material can be a woven fabric, a non-woven or a knitted fabric, for example. The textile material may, for example, be made of natural materials, such as cotton, or of chemical fibres made of natural and synthetic raw materials, such as polyarnide, polyester, or glass fibres, but also of mixed forms of both materials, whereby a textile material made of polyester is preferred.

Advantageously, the textile material is a knitted or crocheted fabric, so that fully finished parts can be produced. This has the advantage that with the elasticity typical for knitted fabrics, the fully finished parts have an optimum fit so that they can be used without any further processing steps.

In order not to impair the penetration of the airbag, textile material with lower tear resistance is preferably used.

The thickness of the textile layer is preferably 0.05 to 2.0 mm, more preferably 0.1 to 1.0 mm and even more preferably 0.2 to 0.8 mm.

Adhesive

The adhesive used in the present invention is preferably a hot melt adhesive known and used in the state of the art. For example, the adhesive is used in a thickness of 40 μm.

A preferred hot melt adhesive is based on polyurethane (PUR).

The foam layer, cover layer and lacquering layer contained in the composite structure according to the invention can have adhesive properties so that they can adhere firmly to each other without the addition of another adhesive. The adhesive mentioned in the present invention therefore refers to a material which is different from the material of the respective layers involved in the composite structure according to the invention.

For example, if no adhesive is present in a composite structure between the foam layer and the cover layer, this means that no adhesive material is present that differs in composition from the material of the foam layer or cover layer.

If no adhesive is present in a composite structure between the textile layer and a PVC sublayer of the cover layer, this means that no adhesive material is present which differs in composition from the material of the textile layer or the PVC sublayer.

A preferred embodiment of the composite structure according to the invention comprises a foam layer, a cover layer and a lacquering layer in that order, with no adhesive between these structures.

Another preferred embodiment of the composite structure according to the invention comprises a foam layer, an adhesive layer, a textile layer, an adhesive layer, a cover layer and a lacquering layer in that order. If, in this configuration, the cover layer contains a sublayer of PVC adjacent to the foam layer, the latter may serve as an adhesive layer.

### EXAMPLES

The present invention is further illustrated by the following examples.

(a) Measurement Methods

In the present invention, the following measuring methods were used to determine the parameters of the composite structure:

(The norms and standards indicated in the present notification refer to the versions current at the time of notification, unless otherwise indicated)

Cover Layer

Thickness: ISO 1923; weight: ISO 2286-2:2016; hardness: DIN 53505; melting points (DSC): ASTM D 3418-15

Textile Layer

Weight: EN 40-339-02; tear propagation strength: DIN 53356; elongation at break: ISO 13934-1:99

Foam Layer

Thickness: ISO 1923; density: ISO 845; melting point (DSC): ASTM D 3418-12

Composite Structure

Hardness (Shore A, ShA): DIN 53505

Wrinkle formation: A sample of the composite material, 7 mm long and 4.5 mm wide, was folded with the foam side facing outwards and placed in a device used in a fracture resistance test according to VDA 230-225, then a load of 1.4 kg was applied to the wrinkled area for one minute, the sample was removed, placed on a flat surface and then visually assessed to see whether the sample returned to its original state or whether a wrinkle remained.

Puncture test: ISO 3303-1; elongation at break: ISO 1421; tear propagation strength: DIN 53356;

Adhesion strength polymer/foam, polymer/textile and textile/foam: ISO 2411

Gel content: Measurement of gel content is based on ASTM D2765-16. The composite is weighed (initial weight) and immersed in xylene at 180° C. for 24 hours, after which the dissolved material is separated and the weight of the remaining material is determined (final weight); gel content [%]=[(final weight−initial weight)/starting weight)]×100

(b) Implementation of the Examples

Imitation leather of the composition given in Table 1 was produced.

The arrangement of the sublayers from top to bottom as shown in Table 1 corresponds to the arrangement from outside to inside in the composite structure, i.e. in the direction from the lacquering layer to the foam layer.

The structure of the artificial leather and its production are explained in more detail below for the composite structures of examples 1, 4 and 6.

### Example 1

The artificial leather of example 1 has the following structure;
Layer 0: lacquer based on silicone-containing aliphatic polyurethane, approx. 5 μm thick
Layer 1: compact TPO layer (approx. 130 μm layer thickness)
Layer 2: compact TPO layer (approx. 130 μm layer thickness)
Layer 3: compact TPO layer (approx. 130 μm layer thickness)
Layer 4: polypropylene foam (3500 to 4000 μm layer thickness; sharpened foam)

Layers 1 to 3 correspond to layers AA-B in Table 1.

The composite structure can be produced by a process with the following steps:
(i) coextrusion of the TPO layers and thermal lamination to PP foam
(ii) lacquering of the upper side and, optionally, the reverse side
(iii) embossing to form the grain
(iv) optionally lacquering the reverse side

An alternative procedure includes the following steps:
(i) coextrusion of the TPO layers
(ii) lacquering of the upper side
(iii) embossing to form the grain and lamination on PP foam
(iv) optionally lacquering the reverse side

### Example 4

The artificial leather of example 4 has the following structure:
layer 0: lacquer based on silicone-containing aliphatic polyurethane, approx. 5 μm thick
Layer 1: compact TPO layer (approx. 130 μm layer thickness)
Layer 2: compact TPO layer (approx. 130 μm layer thickness)
Layer 3: compact TPO layer (approx. 130 μm layer thickness)
Intermediate layer: hot melt adhesive, 40 μm thick
Layer 4: 100% polyester textile, 400 to 600 μm thick
Intermediate layer, hot melt adhesive, 40 μm thick
Layer 5: polypropylene foam (3500 to 4000 μm layer thickness, sharpened foam)

Layers 1 to 3 correspond to layers A-B-A in Table 1.

The composite structure can be produced by a process with the following steps:
(i) coextrusion of the TPO layers
(ii) lacquering of the upper side
(iii) hot melt bonding the TPO layers and the polypropylene foam to the polyester textile
(iv) embossing to form the grain
(v) optionally lacquering of the reverse side

Step (v) can be performed before step (iv).

An alternative procedure includes the following steps:
(i) coextrusion of the TPO layers
(ii) hot melt bonding the TPO layers and the polypropylene foam to the polyester textile
(iii) lacquering of the top and, optionally, the reverse side

### Example 6

The artificial leather of example 6 has the following structure:
Layer 0: lacquering based on aliphatic polyurethane containing silicone, approximately 5 μm thick
Layer 1: compact PVC layer (approx. 220 μm layer thickness) (PVC1)
Layer 2: PVC foam layer (approx. 430 μm layer thickness) (PVC2)
Layer 3: compact adhesive layer based on PVC (approx. 40 μm layer thickness) (PVC3)
Layer 4: 100% polyester textile, 400 to 600 μm thick
Intermediate layer: hot melt adhesive, 40 μm thick
Layer 5: Polypropylene foam (3500 to 4000 μm layer thickness; sharpened foam)

PVC3 serves as an adhesive layer.

Layers 1 to 3 correspond to layers PVC1 to PVC3 in Table 1.

The composite structure can be produced by a process with the following steps:
(i) covering the PVC layers and laminating the polyester textile
(ii) lacquering of the upper side
(iii) embossing to form the grain
(iv) hot melt bonding of the polypropylene foam to the polyester textile
(v) optionally lacquering of the reverse side

(c) Results

The properties of these synthetic leathers with regard to creasing and suitability as airbag covers were investigated.

The wrinkling was determined under the following conditions:
Test 1: Wrinkle formation after 1-minute buckling at room temperature with a load of 1.4 kg.
Test 2: Wrinkle formation after each 1-minute buckling at room temperature and 90° C. at a load of 1.4 kg.

The grading of the wrinkling was done after bending in longitudinal, transverse and diagonal directions:
Grade 1: no or hardly visible wrinkling
Grade 2: hardly visible wrinkling
Grade 3: clearly visible wrinkling

The tearing properties of airbag shots were investigated at −35° C., 23° C. and 85° C.

In the Examples and Comparison Examples, sublayers of thermoplastic polyolefin with the following Shore A hardnesses (ShA) were used: XAKU: ShA 71; XZCI: ShA 86; XAKY: ShA 77; XAKJ: ShA 86; XZTE: ShA 68.

Polyester (PES) was used as the textile layer and polypropylene (PP) as the foam layer.

The results are shown in Table 1.

TABLE 1

| | Comp. | Example | | | Comp. | Example | | |
|---|---|---|---|---|---|---|---|---|
| | Example 1 | 1 | 2 | 3 | Example 2 | 4 | 5 | 8 |
| Arrangement of | AA-XAKU | AA-XAKU | AA-XAKU | AA-XAKY | A-XAKJ | A-XAKJ | A-XAKJ | PVC1 |
| the sublayers of | (71) | (71) | (71) | (77) | (86) | (86) | (86) | |
| the cover layer | | | | | | | | |
| (Shore A hardness) | B-XZCI | B-XZCI | B-XAKY | B-XAKY | B-XZTE | B-XZTE | B-XZTE | PVC2 |
| | (86) | (86) | (77) | (77) | (68) | (68) | (68) | |
| | | | | | A-XAKJ | A-XAKJ | A-XAKJ | PVC3 |
| | | | | | (86) | (86) | (86) | |
| Total thickness [mm] | 0.40 | <0.40 | 0.40 | 0.40 | 0.50 | 0.50 | 0.50 | 0.70 |
| of the cover layer | | | | | | | | |
| Textile layer | — | — | — | — | PES | PES | — | PES |
| Thickness [mm] of the | 4.0 | 3.5 | 3.5 | 3.5 | — | 3.5 | 3.5 | 3.5 |
| foam layer (PP, 50 | | | | | | | | |
| kg/m³) | | | | | | | | |
| Grading of wrinkling, | 3 | 2 | 2 | 2 | 2 | 1 | 1 | 1 |
| test 1 | | | | | | | | |
| Grading of wrinkling, | 3 | 1 | 2 | 1 | | | | |
| test 2 | | | | | | | | |

| | |
|---|---|
| Teasing properties | The samples were suitable for use in airbags; the products of samples 2 and 3 tore late |
| at airbag firing | |

The products of the examples 1 to 6 according to the invention fulfilled the following criteria of the airbag evaluation: particle flight, crack pattern of the surface, inflation behavior of the airbag, flap movement, tear time and adhesion of the decoration to the carrier.

The products in the comparative examples fulfilled the criteria for the airbag rating only by weakening the material.

Further Trials

The composite structures of examples 1, 4 and 6 were subjected to further investigations and comparisons with the composite structures C212 and PVC/Spacer of the state of the art.

C212

The artificial leather C212 has a material weakening introduced by laser treatment and has the following structure:
Layer 0: lacquer based on silicone-containing aliphatic polyurethane, approx. 5 μm thick
Layer 1: compact TPO layer (approx. 190 μm layer thickness)
Layer 2: compact TPO layer (approx. 190 μm layer thickness)
Layer 3: compact TPO layer (approx. 190 μm layer thickness)
Layer 4: polypropylene foam (2000 μm layer thickness; no sharpened foam)

The composite structure C212 can be produced by a process with the following steps:
(i) coextrusion of the TPO layers and thermal lamination to PP foam
(ii) lacquering of the upper side and, if necessary, the reverse side
(iii) embossing to form the grain
(iv) optionally lacquering the reverse side

Alternatively, the composite structure C212 is produced by the following process:
(i) coextrusion of the TPO layers
(ii) lacquering of the upper side
(iii) embossing to form the grain and thermal lamination to polypropylene foam
(iv) optionally lacquering the reverse side

PVC/Spacer

The imitation leather PVC/Spacer has the following structure:
Layer 0: lacquer based on silicone-containing aliphatic polyurethane, approx. 5 μm thick
Layer 1: compact PVC layer (approx. 230 μm layer thickness)
Layer 2: compact PVC layer (approx. 230 μm layer thickness)
Intermediate layer: hot melt adhesive, 40 μm thick
Layer 3: spacer textile (3500 to 4000 μm layer thickness)

Results

The results are shown in Table 2.

TABLE 2

| | | C212 | PVC/Spacer | Example 1 | Example 4 | Example 6 |
|---|---|---|---|---|---|---|
| | Features | | | | | |
| | Structure (ShA) | AA-XAKJ (85) | — | AA-XAKU (71) | A-XAKJ (86) | PVC1 |
| | | B-XZCI (86) | | B-XZCI (86) | B-XZTE (68) | PVC2 |
| | | | | | A-XAKJ (86) | PVC3 |
| Cover | Thickness (mm) | 0.57 | 0.57 | 0.4 | 0.4 | 0.7 |
| layer | Weight (g/m²) | 507 | — | 348 | 448 | 605 |
| | Hardness (ShA) | 86 | | 81 | 81 | 43 |
| | Melting point | Tf1 = 118 | | Tf1 = 118 | Tf1 = 117 | gelation >182° C. |
| | (° C.) | Tf2 = 162 | | Tf2 = 160 | Tf2 = 162 | |
| | Gel content (%) | 24.5 | 1.84 | 15.6 | 5.6 | 1.55 |
| Adhesive | Type | — | — | — | PUR hot melt | — |
| | | | | | adhesive | |
| | Quantity (gm²) | | | | 40 | |
| Textile | Type | — | Spacer | — | 100% PES | |
| layer | Weight (g/m²) | | fabric | | 52 | |
| | Tensile strength | | 3.50-4.00 mm | | 161/146 | |
| | warp/weft (N) | | | | | |
| | Tear propagation | | thick | | 17/20 | |
| | strength warp/weft (N) | | | | | |
| | Elongation at break | | | | 176/113 | |
| | warp/weft (%) | | | | | |
| Adhesive | Type | — | — | — | PUR hot melt adhesive | |
| | Quantity (g/m²) | | | | 40 | |
| Foam layer | Thickness (mm) | 2.0 | — | 3.5 | | |
| | Weight (g/m²) | 134 | | 175 | | |
| | density (kg/m³) | 67 | | 50 | | |
| | Gel content (%) | 65.3 | | 56.5 | | |
| | Melting point | Tf1 = 121 | | Tf1 = 119 | | |
| | (° C.) | Tf2 = 152 | | Tf2 = 145 | | |
| Composite | Hardness (ShA) | 48 | 34 | 30 | 44 | 34 |
| structure | Tearing properties | * | ** | * | * | * |
| | at airbag firing | | | | | |
| | Adhesion | *** | — | *** | — | — |
| | Polymer/foam (N) | | | | | |
| | Adhesion | — | *** | — | *** | *** |
| | Polymer/textile (N) | | | | | |
| | Adhesion | — | — | — | *** | *** |
| | textile/foam | | | | | |
| | Grading of wrinkling, | 3 | 1 | 2 | 1 | 1 |
| | test 2 | | | | | |

* The samples were suitable for use as airbag covers at −35° C., 23° C. and 85° C.
** No test possible.
*** No separation of the layers possible without destruction of the layers, especially the foam layer (foam splitting).

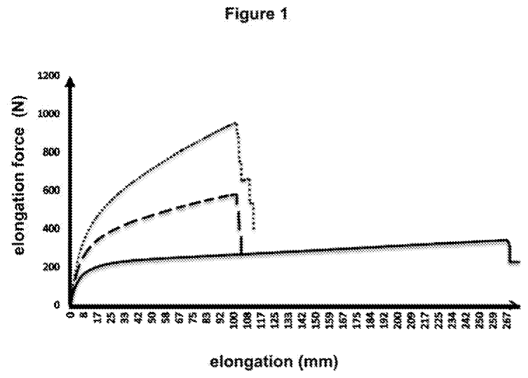

FIG. 1 shows the excellent elongation properties of the composite structures of examples 4 and 6.

What is claimed is:

1. A composite structure as a coating for an airbag cover, the composite structure having a Shore A hardness according to DIN 53505 of 20 to 45, comprising a foam layer, a cover layer and a lacquering layer, the foam layer having a density of 40 to 100 kg/m³ and a gel content of 20 to 80% and containing a polyolefin and the cover layer having a gel content of 0 to 20%, being thermoplastic and comprising at least two compact sublayers each comprising at least one thermoplastic selected from polyolefin and polyvinyl chloride.

2. The composite structure according to claim 1, wherein the gel content of the cover layer is 3 to 15%, the sublayers of the cover layer contain polyolefin and the sublayer of the cover layer closest to the foam layer has a Shore A hardness of 75 to 95 and the sublayer adjacent thereto has a lower Shore A hardness.

3. The composite structure according to claim 1, wherein the gel content of the cover layer is 1 to 5%, the sublayers of the cover layer contain polyvinyl chloride and together have a Shore A hardness of 30 to 60.

4. The composite structure according to claim 1, wherein the polyolefin of the foam layer contains polypropylene.

5. The composite structure according to claim 1, wherein a textile layer of a thickness of 0.05 to 2 mm is arranged between the foam layer and the cover layer.

6. The composite structure according to claim 1, where the thickness of the foam layer is 1 to 5 mm and the thickness of the cover layer is 0.2 to 1 mm.

7. The composite structure according to claim 1, wherein the foam layer consists of sharpened foam.

8. A process for producing a composite structure according to claim 1, wherein the sublayers of the cover layer contain thermoplastic polyolefin and no textile layer is disposed between the foam layer and the cover layer, the process comprising the following steps (i) to (iii) in one of the alternative sequences indicated:
(i) coextruding the sublayers of the cover layer and thermally laminating to the foam layer,
(ii) lacquering the cover layer and,
(iii) if the composite structure has a grain, embossing the structure to form the grain; or
(i) coextruding the sublayers of the cover layer,
(ii) lacquering the cover layer and,
(iii) if the composite structure has a grain, embossing the structure to form the grain and thermally laminating it to the foam layer.

9. A process for producing a composite structure according to claim 1, wherein the sublayers of the cover layer contain thermoplastic polyolefin and a textile layer is arranged between the foam layer and the cover layer, the method comprising the following steps:
(i) coextruding the sublayers of the cover layer,
(ii) lacquering the cover layer,
(iii) hot-melt bonding the cover layer and the foam layer to the textile layer and,
(iv) if the composite structure has a grain, embossing the structure,
wherein the steps are performed in the order indicated or in the order (i), (iii), (ii) and (iv).

10. A process for producing a composite structure according to claim 1, wherein the sublayers of the cover layer contain thermoplastic polyvinyl chloride and a textile layer is arranged between the foam layer and the cover layer, the process comprising the following steps:
(i) providing the textile layer with laminated sublayers of the cover layer
(ii) lacquering the cover layer,
(iii) if the composite structure has a grain, embossing the structure; and
(iv) hot-melt bonding the foam layer to the textile layer.

11. A sewn product obtainable by sewing together at least two sheets of the composite structure according to claim 1.

12. The sewn product according to claim 11, wherein the product is obtainable by folding the composite structure, placing the foam layers together and sewing the two parts of the composite structure in the contact area.

13. The sewn product according to claim 11, wherein the thickness of the foam layer in the area of the seam has been reduced before sewing.

14. The use of a composite structure according to claim 1 as a coating material for an airbag cover in the interior of a vehicle.

15. The use of a sewn product according to claim 11 as a coating material for an airbag cover in the interior of a vehicle.
